(19) United States
(12) Patent Application Publication
(10) Pub. No.: US 2007/0145166 A1
(43) Pub. Date: Jun. 28, 2007

(54) Device and method for transport and cleaning of air

(76) Inventor: Andrzej Loreth, Akersberga (SE)

Correspondence Address: YOUNG & THOMPSON, 745 SOUTH 23RD STREET, 2ND FLOOR, ARLINGTON, VA, 22202, US

(21) Appl. No.: 10/582,877

(22) PCT Filed: Dec. 15, 2004
(86) PCT No.: PCT/SE04/01895

§ 371 Date: Jul. 11, 2006

(30) Foreign Application Priority Data
Dec. 15, 2003 (SE) 0303349-5

(51) Int. Cl. F23D 11/32; B05B 5/00

(52) U.S. Cl. 239/690; 239/690.1; 239/706

(57) ABSTRACT

A device for transport and cleaning of air by using electric ion wind, includes an elongated corona electrode), a target electrode and a direct current source that has one terminal connected to the corona electrode and the other terminal to the target electrode, the design and voltage of the corona electrode between the terminals being such that a discharge generating air ions occurs at the corona electrode. The target electrode has an extension in the longitudinal direction of the corona electrode an extension transverse to the longitudinal direction of the corona electrode. The target electrode has a certain permeability to the air flow that is generated between the electrodes, and the device has outlet openings for the air flow.

### TECHNICAL FIELD OF THE INVENTION

The present invention relates to device and a method for transport and cleaning of air by using electric ion wind, said device comprising an elongated corona electrode, a target electrode arranged at a distance from the corona electrode and a direct current source that has one terminal connected to the corona electrode and the other terminal to the target electrode, the design and voltage of the corona electrode between the mentioned terminals of the direct current source being such that a discharge occurs at the corona electrode, said discharge generating air ions, that the target electrode on one hand has an extension in the longitudinal direction of the corona electrode and on the other hand an extension transverse to the longitudinal direction of the corona electrode, that the target electrode has a certain permeability to the air flow that is generated between the electrodes, and that the device has outlet openings for the air flow.

### PRIOR ART

A typical device that uses ion wind technique comprises in principle an air flow duct and a corona electrode and a target electrode arranged at a distance from each other in the air flow direction, the target electrode being located downstream the corona electrode. The corona electrode and the target electrode are each connected to a terminal of a direct current source, the design of the corona electrode and the voltage difference and distance between the corona electrode and the target electrode are such that a corona discharge occurs at the corona electrode. This corona discharge generates air ions having the same polarity as the polarity of the corona electrode and possibly also charged aerosols, i.e. solids or liquid drops that are present in the air, said solids or drops being charged by collisions with the charged air ions. The air ions migrate, by influence from the electrostatic field, rapidly from the corona electrode to the target electrode where they emit their electric charge and again become uncharged air molecules. During this movement the air ions permanently collide with the non-charged air molecules and the electrostatic forces are transferred also to air molecules, thus bringing them to be drawn in direction from the corona electrode towards the target electrode. Thereby an air flow in the shape of an ion wind or corona wind is established in the air flow duct.

Preferred embodiments of air transporting devices of the type defined above are described for instance in the international applications PCT/SE85/00236 and WO 89/00355 or WO 96/33539. In air transporting devices of this kind the corona electrode may for instance be designed as a thread shaped element, the thread shaped elements extending across the air flow duct that has a rectangular or square cross section, the thread shaped corona electrode elements being provided in direction of the major axis of an intended air flow duct.

In other types of corona elements the problems that are solved by the present invention and described below are of the same character and therefore the description of these problems is concentrated to embodiments having elongated corona electrode as ion source, this being the most common in field tests.

As is evident from the above mentioned PCT/SE85/00236 the efficiency of the air transport is directly dependent from the ion current, i.e. the intensity of the corona current and the distance between the corona electrode and the target electrode. By the aid of a so-called screening electrode and/or by the aid of a suitable voltage polarity between the polarity of the corona electrode and the polarity of the target electrode vis-à-vis earth the migration of the air ions in the direction opposite the desired air flow direction may be prevented. Further, the ion current should be as evenly distributed as possible across the entire cross section area of the air flow duct. A certain equalization of the distribution of the air flow through the duct has been achieved by the aid of duct electrodes that are described in WO 96/33539.

Despite basic knowledge of the ion wind phenomena and its operation parameters the ion wind technique has not yet come into general use. A basic reason therefore is the generation of ozone and nitrogen oxides around the corona electrode.

The development of the ion wind technique, for instance described in the above mentioned patent documents, has essentially been aiming at reducing the need of corona current per transported air volume through an ion wind device, i.e. to reduce the generation of ozone. Despite all described improvements no device has been created where the generation of ozone is nearly eliminated before the air flow leaves the device.

An interesting proposal to take care of the ozone that is generated at the corona electrode is described in WO 89/00355 (FIGS. 10 and 14), where a smaller portion of the air flow is intended to pass through an opening in the target electrode that is arranged axially and opposite the corona electrode. However, this solution has not been put into practice due to the fact that the relatively seen large distance between the corona electrode and the target electrode brings about that the ozone that is generated at the corona electrode is spread to the closest air layer of the air flow, i.e. the concentration of these gases decreases when they, by means of the air flow, are moved towards the target electrode. A smaller gap opening, as suggested in the above mentioned application, is not producing the sufficient entrainment, especially in case a kind of chemical absorbent is provided as illustrated in FIG. 14 in WO 89/00355. Such an absorbent creates a relatively high pressure drop and hence the entrainment ability is further decreased. A wider gap opening will increase the entrainment ability but simultaneously there is a dramatic increase of the air flow volume that must be taken care of and purified from ozone, nitrogen oxides and not least particles if the device is to be used as air cleaner. What has been said above seems to be the reason that the solution of the above mentioned publication not has been put into practice.

### OBJECTS AND FEATURES OF THE INVENTION

A primary object of the present invention is to provide an air transporting device by using so called ion wind or corona wind, the above discussed problem relating to ozone and nitrogen oxides being almost eliminated with said device.

A further object of the present invention is that the device according to present invention also should clean the air.

At least the primary object of the present invention is realized by means of the device and the method that has been given the features of the appending independent claims. Preferred embodiments of the invention are defined in the dependent claims.

### BRIEF DESCRIPTION OF THE DRAWINGS

Below a number of embodiments of the invention will be described, reference being made to the accompanying drawings, where:

FIG. 1 shows schematically an example of a first embodiment of an air transporting/air cleaning device according to the invention;

FIG. 2 shows schematically an example of a second embodiment of an air transporting/air cleaning device according to the invention;

FIG. 3 shows schematically an example of a further embodiment of an air transporting/air cleaning device according to the invention;

FIG. 4a shows schematically an example of a further embodiment of an air transporting/air cleaning device according to the invention;

FIG. 4b shows schematically an example of a further embodiment of an air transporting/air cleaning device according to the invention; and

FIG. 5 shows schematically an example of a further embodiment of an air transporting/air cleaning device according to the invention.

### DETAILED DESCRIPTION OF PREFERRED EMBODIMENTS OF THE INVENTION

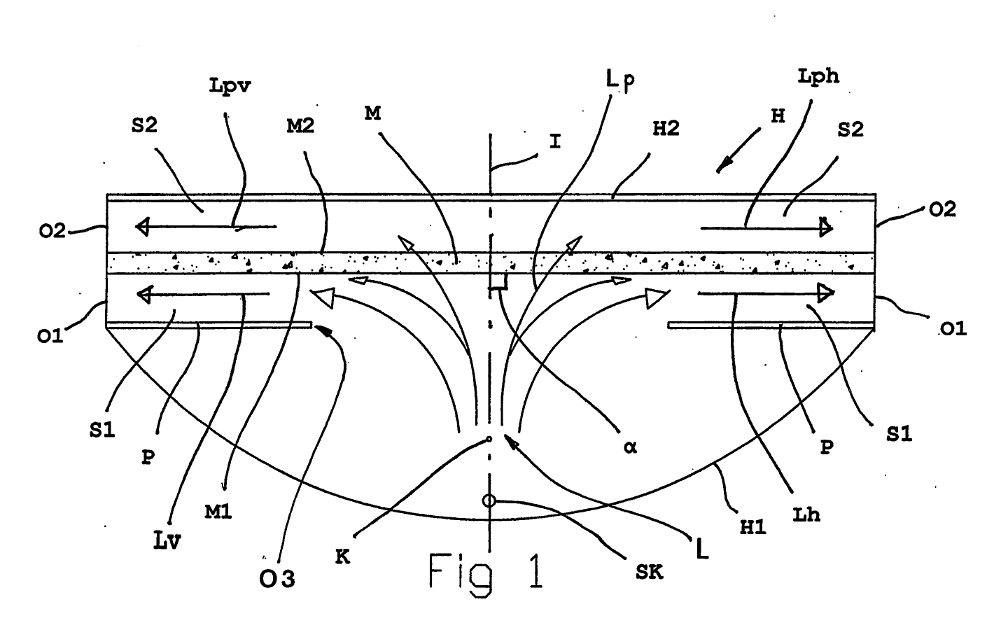

The device according to the present invention shown in FIG. 1 comprises a housing H that in the shown embodiment comprises a curved first limiting surface H1 and a planar second limiting surface H2, said surfaces generally having an extension transverse to the plane of the paper in FIG. 1. Besides the housing H comprises two end surfaces (not shown) that are arranged at a distance from each other and generally have an extension in the plane of the paper in FIG. 1. The two limiting surfaces H1, H2 and the two end surfaces together define a space, in which the components necessary to generate an ion wind are provided. In the housing H in FIG. 1 there are also provided two diametrically located first openings O1 and two diametrically located second openings O2. The openings O1, O2, located on the same side of the device, are separated by an edge portion of a target electrode M that will be described below.

The housing H is preferably manufactured from an electrically conductive material, a semi-conductive material or a highly resistive material (anti-static/dissipative material). As an alternative the housing H may have an internal coating of said materials. Inside the housing H a target electrode M is provided, said target electrode M being in the shape of a planar disc that comprises a structure that to some extent is permeable to the air flow L. Inside the housing H a corona electrode K is provided upstream the target electrode M, said corona electrode K being thread shaped and parallel to the target electrode M. Both the target electrode M and the corona electrode K extend between the two planar end surfaces, both the target electrode M and the corona electrode K having an extension perpendicular to the end surfaces. In the embodiment shown in FIG. 1 the target electrode M comprises two perforated (expanded metal) metallic surfaces M1, M2 that between themselves receive activated carbon Ak that is in the shape of a granulate.

Two partitions P are provided in the housing H, said partitions P preferably being located in a common plane. The partitions P are located at a distance from the target electrode M, on the opposite side of the target electrode M compared to the second limiting surface H2. The partitions P define between their adjacent edges a third opening O3, through which the air flow L passes on its way from the corona electrode K to the target electrode M.

As also is shown in FIG. 1 a screening electrode SK is provided inside the housing H upstream the corona electrode K, said screening electrode SK being in the shape of a rod having round cross section. The design of so called screening electrodes and their energizing are known technique and are only shown schematically in FIG. 1.

The corona electrode K and the target electrode M are mutually located in such a way that an imaginary plane I that extends from the centre of the target electrode M and holds the corona electrode K has an extension transverse to the target electrode M or perpendicular to the target electrode M as shown in the embodiment, this being illustrated by the angle α. The imaginary plane I thus has an extension perpendicular to the paper in FIG. 1. By studying FIG. 1 it is realized that due to the location of the target electrode M in relation to the corona electrode K the air flow L that is generated by the ion wind, i.e. the air flow between the corona electrode K and the target electrode M, is forced to deflect into two air flows Lv and Lh having diametrically opposite directions. This is shown in FIG. 1 and a certain pressure rise is created. The air flows Lv and Lh advance in opposite directions in two first air flow ducts S1 along the target electrode M and out through the respective first opening 01. The first air flow ducts S1 are thus defined by one surface M1 of the target electrode M, the partition P and the end walls.

The pressure rise forces a portion Lp of the total air flow L through the target electrode M. It is in this portion Lp of the air flow that the ozone and nitrogen oxides have their maximum concentration, said gases being generated in the absolute vicinity of the corona electrode K. An almost complete decomposition of the ozone and absorption of the nitrogen oxides take place since the major part of these gases, together with the air flow portion Lp, are forced to pass through the porous carbon filter structure of the target electrode M, and a smaller portion of these gases are forced to move in the air flow layer Lh and Lv respectively closest to the gas absorbing structure of the target electrode M. In this connection it should be pointed out that the uneven surface of the expanded metal and the porosity of the gas absorbent Ak bring about that there are vortexes in the air flows Lv and Lh, this being beneficial as regards the decomposition of the ozone and nitrogen oxides. The air flow portion Lp that passes through the target electrode M is then deflected in two opposite directions, i.e. the air flow portion Lp is divided into two sub flows Lph and Lpv that advances forward in two second air flow ducts S2 between the second surface M2 of the target electrode M and the inner side of the second limiting surface H2. The second air flow ducts S2 are thus defined by the second surface M2 of the target electrode M, the second limiting surface H2 and the end walls. These sub flows Lph and Lpv pass eventually out through the respective second opening O2 of the housing H. As regards the outlet openings O1 and O2 they are generally located at a distance from the imaginary plane I.

The second limiting surface H2 of the housing H, or a coating on its inner side, and the partitions P, or a coating on their sides facing towards the target electrode M, may be manufactured from a material that could be energized in such a way that an electrostatic field is created between the external surfaces M1, M2 of the target electrode M and the adherent sides of the second limiting surface H2 and the partitions P. In such a case the housing H is preferably earthed. Thereby, a so called precipitator may be provided in a simple and previously known way.

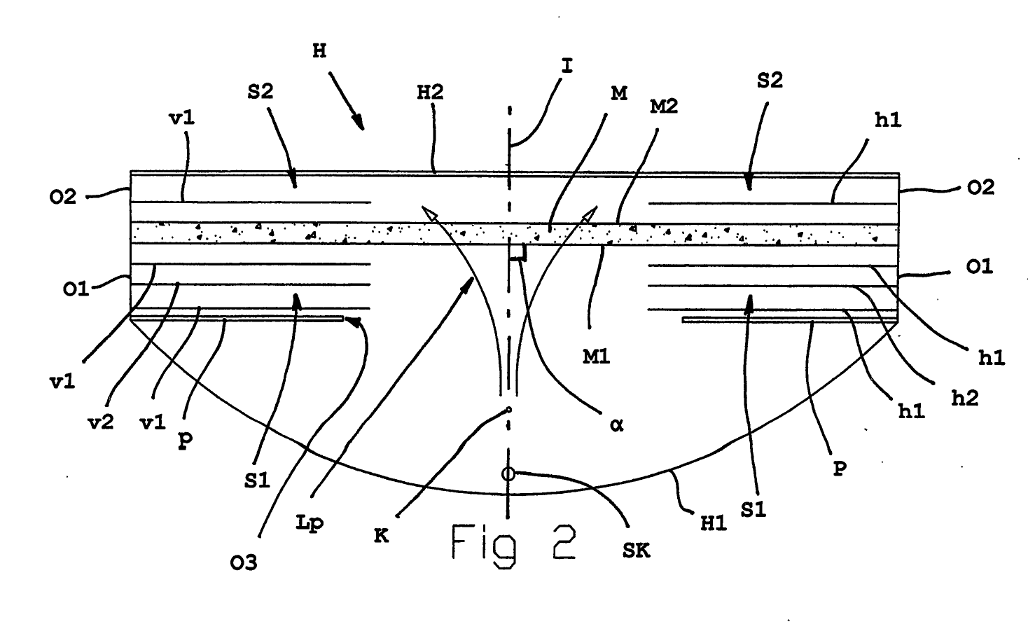

FIG. 2 shows schematically a further developed embodiment of the device according to FIG. 1. The embodiment shown in FIG. 2 also comprises a housing H that in principal has the corresponding design as the housing H according to FIG. 1. As is shown in FIG. 2 a target electrode M is located in the housing H and first and second air flow ducts S1, S2 are defined in a corresponding way as for the embodiment described in FIG. 1. Preferably, the second limiting surface H2 of the housing H may on its inner side and the partitions P may on their sides facing the target electrode M be equipped with a coating of highly resistive material that may be energized in such a way that an electrostatic field is created between the external surfaces M1, M2 of the target electrode M and the adherent sides of the second limiting surface H2 and the partitions P. In such a case the housing H is preferably earthed. In the embodiment shown in FIG. 2 several mutually parallel and planar electrode elements v1, v2 and h1, h2 respectively, or groups of such elements that in a known way constitute so called precipitators, are arranged in the first and second air flow ducts S1, S2. By this arrangement a precipitator may in a simple and previously known way be integrated in the device according to the present invention.

Electrical energizing of the electrode elements v1, v2 and h1, h2 respectively is carried out in a previously known way.

Of course the extension of the target electrode M in the direction Lh and Lv respectively of the air flow may be smaller than the extension of the air flow ducts S1 and S2 respectively in opposite directions. Thus a precipitator may be arranged in both directions and in a prolongation of the target electrode M.

As is also shown in FIG. 2 a screening electrode SK, in the shape of a cylindrical rod, is arranged upstream the corona electrode K. The design of so called screening electrodes and their energizing is previously known from other patent specifications and is only shown schematically in FIG. 2. Of course the present invention is not only restricted to a target electrode M of activated carbon. Other known absorbents may be used, said absorbents should to some extent be permeable to the air flow. It is not necessary that these absorbents have a sufficient conductivity to be able to constitute the target electrode. A practical solution is that the gas absorbent is covered with a conductive or semi-conductive structure M1, M2, said structure also being permeable to the air flow Lp. Often activated carbon is located between surfaces of expanded metal or in the shape of perforated sheet metal plates. There are also other embodiments of carbon filter absorbents. One known such absorbent is marketed by a German company by the name of Blücher.

The permeability of the target electrode M as regards the air flow is difficult to define. Lab tests have shown that about 25-35% of the total air flow volume should pass through the target electrode M in order to achieve almost total ozone reduction. In connection therewith it is evident that the rectangular cross section of the air flow duct, seen in a plane perpendicular to the air flow, preferably should be larger upstream the target electrode M than behind the target electrode, seen from the location of the corona electrode. Thereby, the precipitator upstream the target electrode M has a larger cross section area than the precipitator behind the target electrode M.

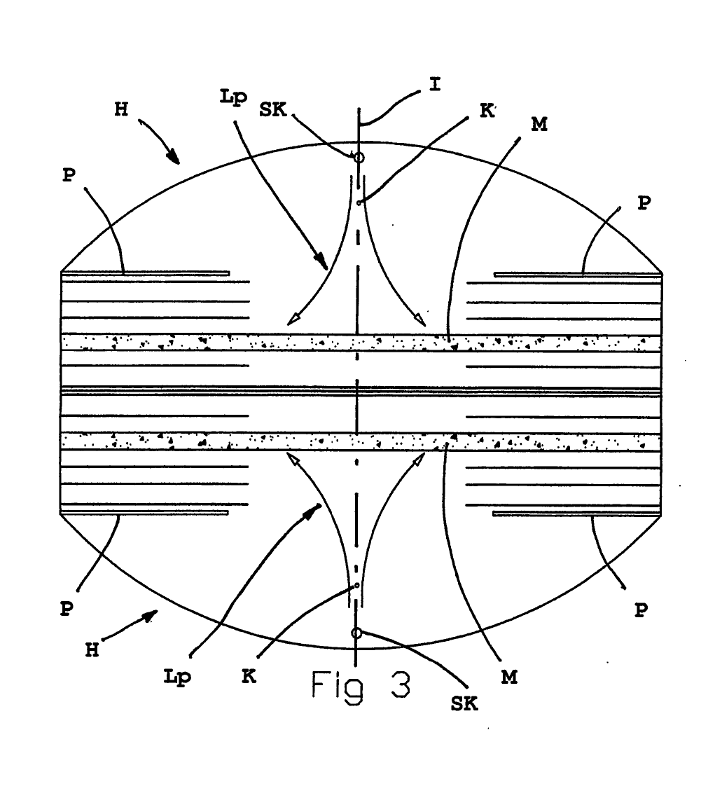

A feasible embodiment of the device according to present invention could preferably comprise two identical modules according to FIG. 2, the backs of the modules facing each other as shown in FIG. 3.

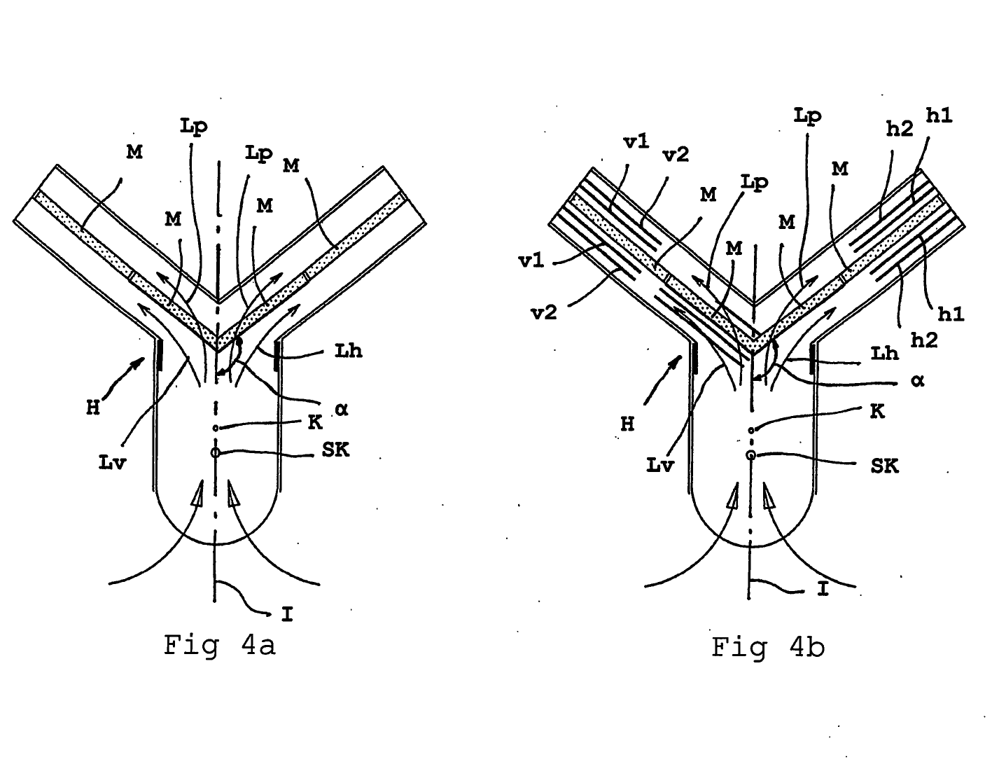

The embodiments described above are designed from a planar target electrode M. However, the planar design of the target electrode M, said electrode being perpendicular to the air flow, may be angled in a V-shape as is shown schematically in FIG. 4a and 4b. Also in connection with these two embodiments an imaginary plane I extends from the centre of the target electrode M and holds the corona electrode K or that, as is shown in the embodiments according to FIGS. 4a and 4b, said imaginary plane I forms an angle α exceeding 90° with one part of the target electrode M, i.e. one “leg” of the V.

In the embodiment according to FIG. 4a precipitators are provided on both sides of the target electrode M since the metallic surfaces M1, M2 of the target electrode M and the walls of the air flow ducts S1, S2, or a coating on their inner sides, being of a material that may be energized in a suitable way thereby creating a precipitator.

In the embodiment according to FIG. 4b further separate electrode elements v1, v2, h1, h2 are provided in the air flow ducts S1, S2. However, such a solution decreases, due to the V-shape, the pressure rise of the air flow L and hence there is an increased risk that the portion of the air flow that is mixed up with the ozone and the nitrogen oxides will not contact the active gas absorbent Ak of the target electrode M.

In the embodiments according to FIG. 4a and 4b the angle α that the imaginary plane I forms with portions of the target electrode M is in the magnitude of 135°, this in practice being close to the upper limit of the angle α.

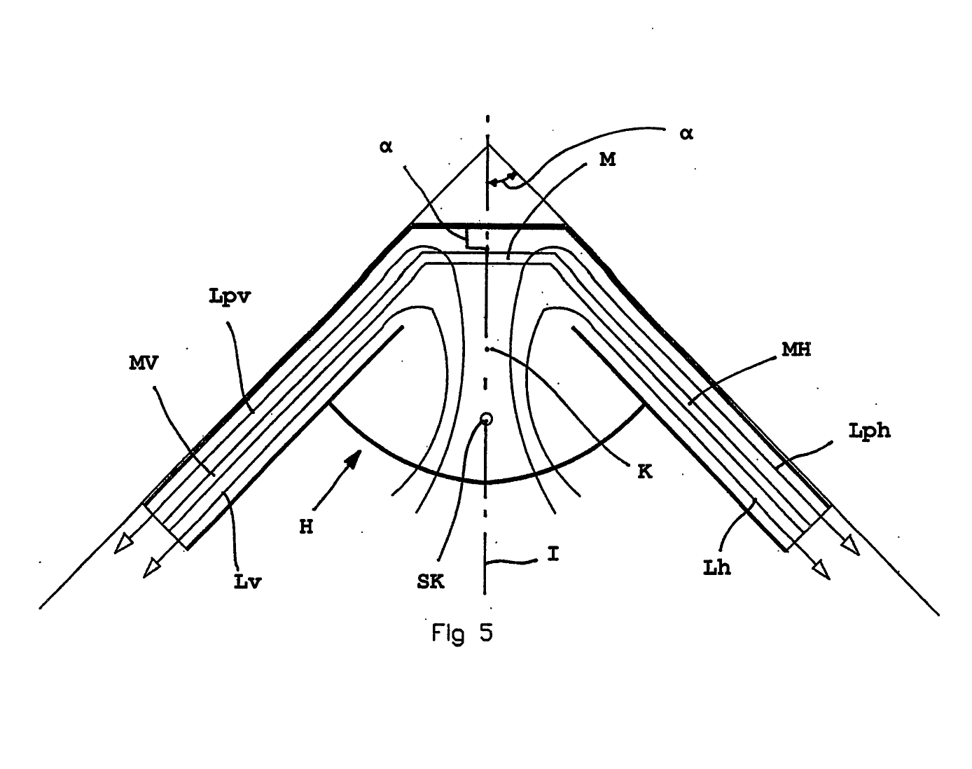

The embodiment of the device according to present invention shown in FIG. 5 is especially designed to be mounted in a corner. Thereby, the target electrode M is divided into three segments MC, MV and MH. MV and MH are located in planes that are perpendicular to each other. Also in this embodiment the imaginary plane I extends from the centre of the target electrode M and holds the corona electrode K, said imaginary plane I extending transverse to the target electrode M. However, the imaginary plane I forms different angles α with different parts MC, MV and MH of the target electrode M. As is evident from FIG. 5 the imaginary plane I forms a right angle with the central segment of the target electrode M. As is also evident from FIG. 5 the two outer segments MV and MH are located in planes that form an angle α with the imaginary plane I, said angle being 45° in the embodiment shown in FIG. 5. Within the scoop of the present invention is is feasible that the portion MC is deleted in the embodiment according to FIG. 5. In such a case the segments MV and MH meet at a right angle in the corner.

The FIGS. 1, 2, 3, 4 and 5 schematically show embodiments of the present invention. Inlet and outlet grids are not shown in the figures. Neither is electric connection of respective electrode elements shown.

Inlet grids may be designed in a previously known way, i.e. by the aid of a structure that is permeable to air flow, e.g. lamellas, perforated plates or the like. The material of the inlet grid may be conductive, semi-conductive, highly resistive (dissipative) or electrically insulating. Alternatively, the inlet grid may be equipped with a coating of the mentioned materials.

As regards the corona electrode K it may generally be mentioned that it should have a sufficient length. In exemplifying and non-restricting purpose the length should be in the interval 50-200 cm. As regards the target electrode M it should have as large surface as practically possible, the extension of the target electrode M in the longitudinal direction of the corona electrode K normally corresponding to the length of the corona electrode K.

As regards the device according to present invention it is stated generally that the corona electrode K and the target electrode M should be mutually oriented in such a way that when the ion wind that emits from the corona electrode hits the target electrode a portion of the air flow that is generated by the ion wind should flow through the target electrode M while a portion of the air flow is deflected along the target electrode M and flows along the target electrode M. Preferably, the target electrode M comprises a porous material that constitutes gas absorbent.

### FEASIBLE MODIFICATIONS OF THE INVENTION

In the embodiments described above the device according to the present invention comprises a screening electrode SK. However, on certain conditions the device according to the present invention may the void of a screening electrode. If the corona electrode for instance is earthed or has a positive potential relative earth and the target electrode has a negative potential relative to earth the screening electrode may the deleted.

Within the scoop of the present invention it is feasible that the corona electrode is segmented, i.e. divided into a number of units that are electrically insulated from each other. This may also be valid as regards the target electrode that likewise may be segmented, i.e. divided into a number of units that are electrically insulated from each other. These units may be connected to a suitable terminal of the high voltage source via a highly resistive resistance. It is certainly feasible that the target electrode comprises several different active gas absorbents. In this connection in should be pointed out that the centre portion of the target electrode M is saturated by gas pollutions more rapidly than the outer portions of the target electrode M. In such a case it might be sufficient to exchange only the central portion that should be easily exchangeable.

With the scoop of the present invention it is also feasible that the air flow ducts on their inner side are coated by gas absorbents that may be energized and act as precipitators.

In the embodiment according to FIG. 1 the target electrode M comprises a granulate that is received between metallic surface layers M1, M2. Within the scoop of the present invention it is also feasible that the target electrode constitutes a gas absorbing material that is self-supporting and also may be energized. In such a case no surface layers are needed. In exemplifying and non-restricting purpose a polyester filter with exploded cells may be mentioned, said filter being coated with a carbon powder by using a binder. Such a material is marketed by a German company by the name of Blücher.

The gas absorbent may be tailor-made for specific gas pollutions and in such a case nitrogen oxides are of a special interest.

1. Device for transport and cleaning of air by using electric ion wind, said device comprising an elongated corona electrode (K), a target electrode (M) arranged at a distance from the corona electrode (K) and a direct current source that has one terminal connected to the corona electrode (K) and the other terminal to the target electrode (M), the design and voltage of the corona electrode (K) between the mentioned terminals of the direct current source being such that a discharge occurs at the corona electrode (K), said discharge generating air ions, that the target electrode (M) on one hand has an extension in the longitudinal direction of the corona electrode (K) and on the other hand an extension transverse to the longitudinal direction of the corona electrode (K), that the target electrode (M) has a certain permeability to the air flow that is generated between the electrodes (K, M), and that the device has outlet openings (O1, O2) for the air flow, characterised in that an imaginary plane (I) that extends from a centre portion of the target electrode (M) and holds the corona electrode (K) has an extension transverse to the target electrode (M) or portions of the target electrode (M), and that the target electrode (M) comprises an active gas absorbent (Ak).

2. Device according to claim 1, characterised in that the imaginary plane (I) forms an angle (α) with the target electrode (M) or portions of the target electrode (M), and that 45°≦α≦135°.

3. Device according to claim 1, characterised in that the gas absorbent (Ak) of the target electrode (M) is encased between air permeable surfaces (M1, M2) of conductive, semi-conductive or dissipative material.

4. Device according to claim 1, characterised in that the target electrode (M) itself constitutes a conductive, semi-conductive or dissipative material.

5. Device according to claim 1, characterised in that the chemical absorbent (Ak) constitutes activated carbon.

6. Device according to claim 1, characterised in that air flow ducts (S1, S2) are provided on both sides of the target electrode (M).

7. Device according to claim 6, characterised in that the walls of the air flow ducts (S1, S2) are manufactured from or coated by material that may be energized to a voltage that is different than the voltage of the target electrode (M), and that the walls or the material are earthed.

8. Device according to claim 6, characterised in that electrode elements (v1, v2, h1, h2) are provided in the air flow ducts (S1, S2), said electrode elements (v1, v2, h1, h2) being part of a precipitator.

9. Device according to claim 1, characterised in that the target electrode (M) has V-shape.

10. Device according to claim 1, characterised in that the target electrode (M) is segmented in units that are electrically insulated from each other.

11. Device according to claim 1, characterised in that the corona electrode (K) is segmented in units that are electrically insulated from each other.

12. Method for transport and cleaning of air by using electric ion wind, said ion wind being generated between a corona electrode (K) and a target electrode (M), characterised in that the ion wind partly passes through the target electrode (M) and partly flows along the target electrode (M) on the side that of the target electrode (M) that faces the corona electrode (K).

13. Device according to claim 2, characterised in that the gas absorbent (Ak) of the target electrode (M) is encased between air permeable surfaces (M1, M2) of conductive, semi-conductive or dissipative material.

14. Device according to claim 2, characterised in that the target electrode (M) itself constitutes a conductive, semi-conductive or dissipative material.

15. Device according to claim 7, characterised in that electrode elements (v1, v2, h1, h2) are provided in the air flow ducts (S1, S2), said electrode elements (v1, v2, h1, h2) being part of a precipitator.
